(19) United States
(12) Patent Application Publication
(10) Pub. No.: US 2017/0308487 A1
(43) Pub. Date: Oct. 26, 2017

(54) DATA TRANSFER CONTROL SYSTEM, DATA TRANSFER CONTROL METHOD, AND PROGRAM STORAGE MEDIUM

(71) Applicant: NEC Platforms, Ltd., Kawasaki-shi, Kanagawa (JP)

(72) Inventor: Minoru ODA, Kanagawa (JP)

(73) Assignee: NEC Platforms, Ltd., Kawasaki-shi, Kanagawa (JP)

(21) Appl. No.: 15/512,604

(22) PCT Filed: Sep. 16, 2015
(86) PCT No.: PCT/JP2015/004709

§ 371 Date: Mar. 20, 2017

(30) Foreign Application Priority Data
Sep. 25, 2014 (JP) 2014-195182

(51) Int. Cl. G06F 13/16; G06F 13/40

(52) U.S. Cl. CPC G06F 13/1689; G06F 13/1673; G06F 13/4068

(57) ABSTRACT

In a system in which a plurality of information processing devices that access data stored in one device according to individual clocks are connected, and data regarding access from another device flows through a path relaying the plurality of information processing devices, a data transfer control system that increases data transfer performance between the information processing devices is disclosed. The data transfer control system is provided with: a synchronization control unit that, when a first information processing device obtains reply data by using a communication path sequentially relayed by a plurality of second information processing devices when accessing any of the second information processing devices that access the stored data in the first information processing device in synchronism with the individual clock signals, outputs the reply data generated in synchronism with the individual clock signals in synchronism with a common clock signal for each of the second information processing devices; and a reply transmission means that stores the reply data, output from the synchronization control unit in synchronism with the common clock signal, for a predetermined time and that then transmits the reply data to the second information processing device of the later stage.

### TECHNICAL FIELD

The present invention relates to a data transfer control system in a system in which a plurality of information processing devices are interconnected in a communicable manner. In particular, the present invention relates to a data transfer control system and the like that, when an information processing device accesses data stored in another information processing device, control transferring the data using a communication path that at least any of the information processing devices inside the system relays in order.

### BACKGROUND ART

With regard to a system in which a plurality of information processing device are interconnected in a communicable manner, various forms for connecting the information processing devices have been known. For example, typical examples relating to a form in which a master device connects a plurality of slave devices to one another include daisy-chain connection. In the daisy-chain connection, a master device connects a plurality of slave devices in a row. In the case in which the master device accesses data stored in a specific slave device, request data that the master device has issued and reply data that the specific slave device has issued are, while being relayed by other slave devices, transferred to a destination device.

In such a system in which a plurality of information processing devices are interconnected via a daisy-chain connection, an advanced data transfer control technology is expected to be applied in the case in which, for example, there is a predetermined condition for timings at which accesses to data stored in a plurality of slave devices are performed. Alternatively, an advanced data transfer control technology is also expected to be applied in the case in which highly-loaded accesses to a plurality of slave devices are performed simultaneously, and the like.

As an example of such a technology, a system in which a plurality of devices are daisy-chained to a host device is disclosed in PTL 1. The system includes a communication device that adjusts latencies (delay time) with respect to the respective devices so that latencies when the host device reads data from the respective devices become the same.

In PTL 2, an apparatus in which devices are coupled together in a daisy chain cascade arrangement is disclosed. In the apparatus, an output unit of a device located at a preceding stage in the daisy chain cascade is coupled to an input unit of a device located at the succeeding stage of the preceding device so as to be able to transfer information and a control signal to devices located at succeeding stages.

### CITATION LIST

### Patent Literature

PTL 1: Japanese Patent Application Laid-open Publication No. 2010-57164

PTL 2: Japanese Patent Application Laid-open Publication No. 2009-301586

### SUMMARY OF INVENTION

### Technical Problem

Slave devices connected to a master device via a daisy-chain connection or the like, in general, operate based on individual clock signals that the respective slave devices generate. Therefore, replies that the respective slave devices issue in response to requests that a master device has issued are issued at timings synchronized with individual clocks, that is, at timings that are asynchronous among the slave devices. For this reason, a fear increases that competition occurs among a plurality of slave devices with respect to a common reply path through which reply data flow.

In order to avoid such competition with respect to a reply path, performing sequential processing by, for example, restricting the number of pieces of reply data that flow through the reply path to one, that is, restricting reply data to only reply data from any one of slave devices at a timing, is conceivable. In this case, however, there is a problem in that not securing sufficient data transfer performance causes system performance to be reduced. The device described in PTL 1 cannot solve such a problem.

A main object of the present invention is to provide a data transfer control system and the like that solves the above problem.

### Solution to Problem

A data transfer control system according to one aspect of the present invention includes:

in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order, the data transfer control system comprising,

with respect to each of the second information processing devices:
synchronization control means for outputting the reply data that the second information processing device creates in synchronization with the individual clock signal in synchronization with a common clock signal that is distributed to the plurality of second information processing devices in common; and
reply transmission means for operating in synchronization with the common clock signal and storing, for a predetermined period of time, the reply data output by the synchronization control means and subsequently transmitting the reply data to the second information processing device located at a succeeding stage or the first information processing device.

In another aspect to achieve the above object, a data transfer control method according to one aspect of the present invention includes:

in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order, the data transfer control system comprising,

by the plurality of the second information processing devices:
outputting the reply data that the second information processing device creates in synchronization with the individual clock signal in synchronization with a common clock signal that is distributed to the plurality of second information processing devices in common; and
storing, for a predetermined period of time, the output reply data and subsequently transmitting the reply data to the second information processing device located at a succeeding stage or the first information processing device in synchronization with the common clock signal.

Furthermore, in another aspect to achieve the above object, a program storage medium according to one aspect of the present invention storing a program that causes a plurality of second information processing devices to execute:

in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order,

a synchronization control process that outputs the reply data that the second information processing device creates in synchronization with the individual clock signal in synchronization with a common clock signal that is distributed to the plurality of second information processing devices in common; and

a reply transmission process that stores, for a predetermined period of time, the reply data output by the synchronization control process and subsequently transmitting the reply data to the second information processing device located at a succeeding stage or the first information processing device in synchronization with the common clock signal.

Furthermore, the present invention is also achievable by a program (computer program) that the above program storage medium stores.

In addition, the above program storage medium may also be a computer-readable non-volatile storage medium.

### Advantageous Effects of Invention

The present invention, in a system in which a plurality of information processing devices each of which accesses data stored in the information processing device using an individual clock signal are interconnected and data relating to an access from another information processing device flow through a communication path relayed by the plurality of information processing devices, enables data transfer performance among the information processing devices to be improved.

### BRIEF DESCRIPTION OF DRAWINGS

FIG. 1 is a block diagram illustrating a configuration of a data transfer control system according to a first example embodiment of the present invention;

FIG. 2 is a block diagram illustrating a configuration of a data processing control unit according to the first example embodiment of the present invention;

FIG. 3 is a diagram exemplifying a configuration of request data according to the first example embodiment of the present invention;

FIG. 4 is a diagram exemplifying a configuration of reply data according to the first example embodiment of the present invention;

FIG. 5 is a block diagram illustrating a configuration of a synchronization control unit according to the first example embodiment of the present invention;

FIG. 6 is an example of a timing diagram relating to data flowing through a request path and a reply path according to the first example embodiment of the present invention;

FIG. 7A is a flowchart (1/2) illustrating an operation of the data transfer control system according to the first example embodiment of the present invention;

FIG. 7B is a flowchart (2/2) illustrating the operation of the data transfer control system according to the first example embodiment of the present invention;

FIG. 8 is a block diagram illustrating a configuration of a data transfer control system according to a second example embodiment of the present invention; and

FIG. 9 is a block diagram illustrating a configuration of an information processing device that is capable of executing processing that a slave device or a second information processing device according to the respective example embodiments of the present invention performs.

### DESCRIPTION OF EMBODIMENTS

Hereinafter, example embodiments of the present invention will be described in detail with reference to the accompanying drawings. The directions of arrows in the respective drawings only illustrate an example and do not limit the directions of signals among blocks.

### First Example Embodiment

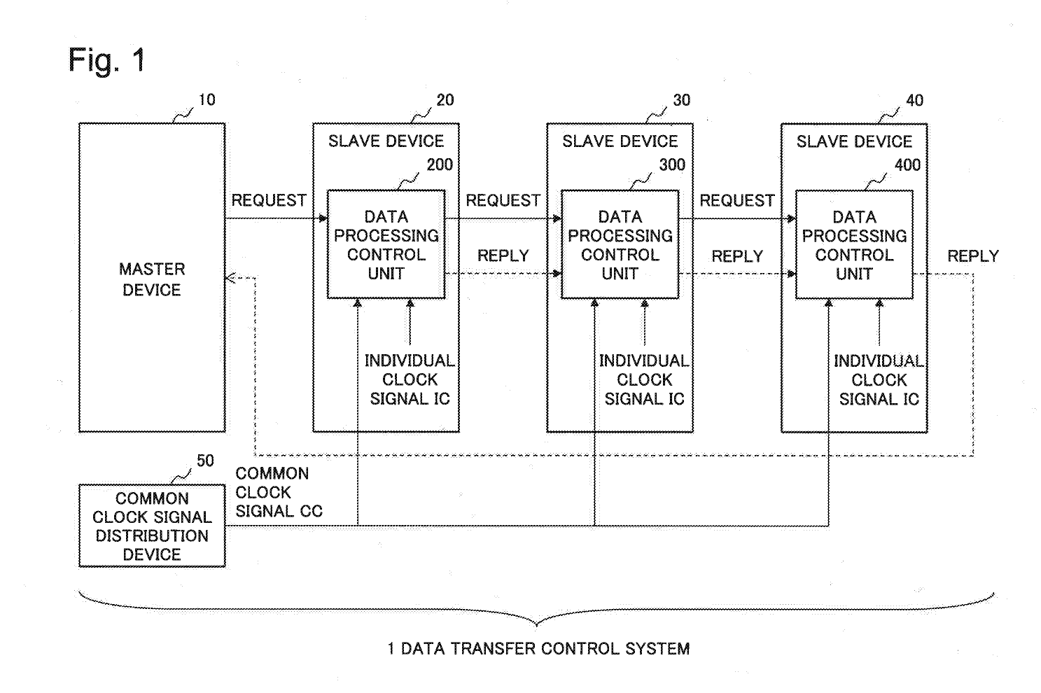

FIG. 1 is a block diagram conceptually illustrating a configuration of a data transfer control system 1 according to a first example embodiment. The data transfer control system 1 according to the present example embodiment includes a master device 10, three slave devices 20 to 40, and a common clock signal distribution device 50. The master device 10 is, for example, an information processing device such as a server device. The slave devices 20 to 40 are devices in which data stored inside the devices are accessed by the master device 10. The slave devices 20 to 40 are, for example, peripheral devices, such as storage devices, that are controlled by the master device 10. In the present example embodiment, the slave devices 20 to 40 are daisy-chained to the master device 10 in a communicable manner. The number of slave devices connected to the master device 10 is not limited to three.

The slave devices 20, 30, and 40 include data processing control units 200, 300, and 400, respectively. To the data processing control units 200, 300, and 400, individual clock signals IC that the slave devices 20, 30, and 40 individually generate are provided, respectively.

The common clock signal distribution device 50 generates a common clock signal CC that the slave devices 20 to 40 use in common and provides the data processing control units 20 to 40 with the common clock signal CC. The common clock signal distribution device 50 does not have to be a single device and may be, for example, an electronic circuit and the like incorporated into the master device 10 or the like.

In accessing data stored in any of the slave devices 20 to 40, the master device 10 issues request data addressed to the destination slave device (slave device to be accessed). The request data flows through a request path relayed by a slave device(s) located between the master device 10 and the destination slave device and are subsequently provided to the destination slave device. The destination slave device performs processing that the provided request data require and subsequently creates reply data that are a result from the processing. The reply data flows through a reply path relayed by a slave device(s) located between the destination slave device and the master device 10 and are subsequently provided to the master device 10.

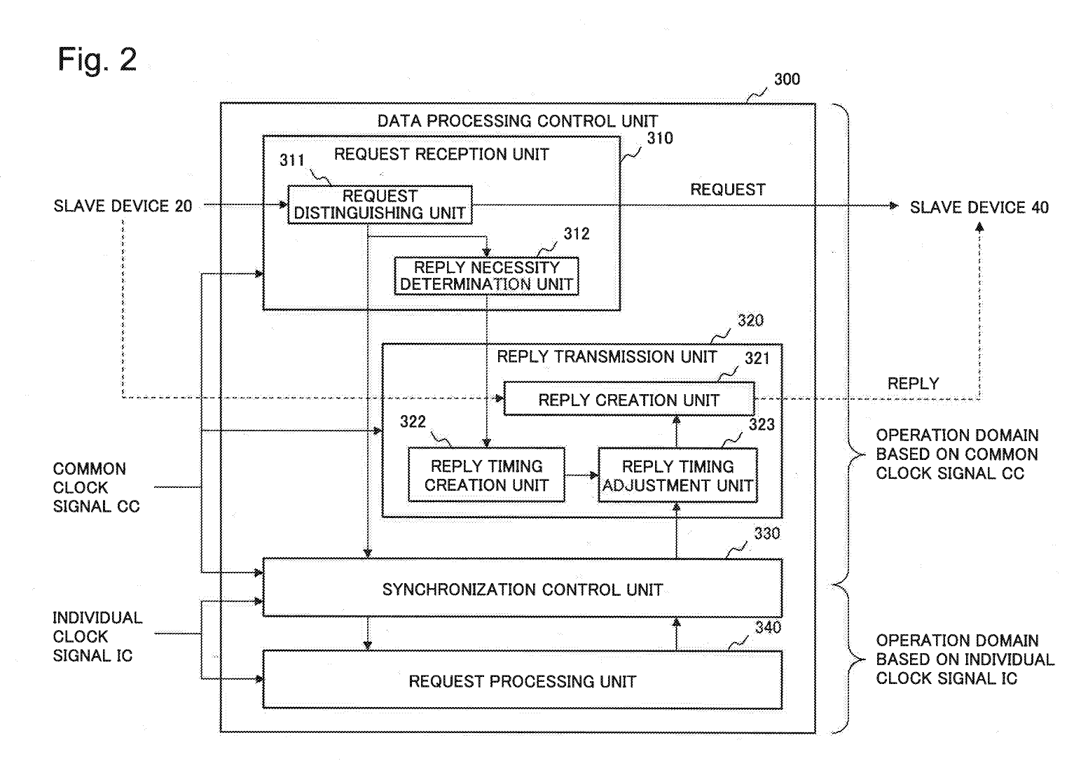

FIG. 2 is a block diagram conceptually illustrating a configuration of the data processing control unit 300 that the slave device 30 according to the present example embodiment includes. The configurations of the data processing control units 200 and 400 that the slave devices 20 and 40 include, respectively, are the same as that of the data processing control unit 300.

The data processing control unit 300 includes a request reception unit 310, a reply transmission unit 320, a synchronization control unit 330, and a request processing unit 340. The request reception unit 310, the reply transmission unit 320, the synchronization control unit 330, and the request processing unit 340 may be achieved by electronic circuits or a computer program and a processor that operates in accordance with the computer program.

The request reception unit 310 includes a request distinguishing unit 311 and a reply necessity determination unit 312. To the request reception unit 310, the common clock signal CC distributed by the common clock signal distribution device 50 is provided. The request reception unit 310 operates in synchronization with the common clock signal CC. The request distinguishing unit 311 receives request data that have been issued by the master device and transferred from the slave device 20, which is located at the preceding stage of the slave device 30 in the daisy-chain connection.

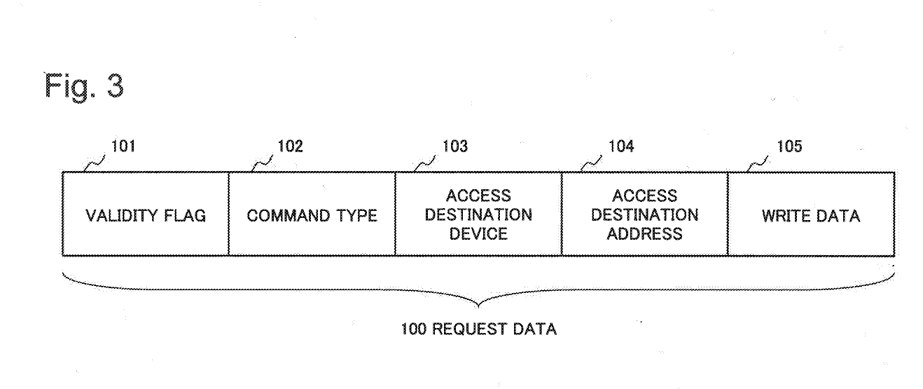

A configuration example of request data according to the present example embodiment is illustrated in FIG. 3. As illustrated in FIG. 3, request data 100 include a validity flag 101, a command type 102, an access destination device 103, an access destination address 104, and write data 105. The validity flag 101 is information that indicates whether or not the request data 100 are valid and contains “1” if valid or “0” if invalid. The command type 102 is information that indicates whether a command indicated by the request data 100 is a read command or a write command. The access destination device 103 is an identifier that makes it possible to identify which one of the slave devices 20 to 40 the master device 10 is accessing. The access destination address 104 is the value of an address at which data that the master device 10 is accessing are stored. The write data 105 are data to be written in the case in which the request data 100 is a write command. In the case in which the request data 100 is a read command, the area for storing the write data 105 is not used.

The request distinguishing unit 311 refers to the access destination device 103 in the received request data 100. In the case in which the access destination device 103 does not indicate the slave device 30 (that is, in the case of indicating the slave device 40), the request distinguishing unit 311 transfers the received request data 100 to the slave device 40, which is located at the succeeding stage of the slave device 30 in the daisy-chain connection. In the case in which the access destination device 103 indicates the slave device 30, the request distinguishing unit 311 provides the reply necessity determination unit 312 and the synchronization control unit 330 with the received request data 100.

The reply necessity determination unit 312 refers to the command type 102 in the request data 100 that has been provided from the request distinguishing unit 311. In the case in which the command type 102 indicates a read command, the reply necessity determination unit 312 determines that a reply to the request is required and provides the reply transmission unit 320 with the determination result. In the case in which the command type 102 indicates a write command, the reply necessity determination unit 312 determines that no reply to the request is required and does not provide the reply transmission unit 320 with the determination result. Although, in the present example embodiment, a description is being made using, as an example, a case in which the slave devices 20 to 40 return a reply to the master device 10 only when a request from the master device 10 is a read command, the configuration is not limited to the case. That is, the slave devices 20 to 40 may be configured to return a result from writing as a reply when the request is a write command. In this case, the request reception unit 310 does not have to include the reply necessity determination unit 312.

The reply transmission unit 320 includes a reply creation unit 321, a reply timing creation unit 322, and a reply timing adjustment unit 323. To the reply transmission unit 320, the common clock signal CC that has been distributed from the common clock signal distribution device 50 is provided. The reply transmission unit 320 operates in synchronization with the common clock signal CC.

In the case of having received reply data that the slave device 20 has created in response to a request from the master device 10, the reply creation unit 321 transfers the reply data to the slave device 40. When reply data that the slave device 30 has created in response to a request from the master device 10 is provided to the reply creation unit 321 from the reply timing adjustment unit 323, the reply creation unit 321 transfers the reply data to the slave device 40.

When a determination result relating to a reply is provided to the reply timing creation unit 322 from the reply necessity determination unit 312, the reply timing creation unit 322 creates reply timing information in accordance with a predetermined criterion. The reply timing information is information that indicates a timing at which the slave device 30 transfers reply data that the slave device 30 has created to the slave device 40. For example, it is assumed that such a predetermined criterion is defined as “three cycles, based on cycles regarding the common clock CC, after the slave device 30 has received request data addressed to the slave device”. In this case, the reply timing creation unit 322 provides the reply timing adjustment unit 323 with an instruction to transfer reply data at a timing based on the created reply timing information. This operation enables the reply transmission unit 320 to transfer reply data after three cycles from receiving of the request data in the request reception unit 310.

In the case in which the reply timing adjustment unit 323 is provided, from the synchronization control unit 330, with reply data that the slave device 30 has created in response to a request from the master device 10, the reply timing adjustment unit 323 stores the reply data temporarily. When the reply timing adjustment unit 323 is provided with an instruction to transfer the reply data from the reply timing creation unit 322, the reply timing adjustment unit 323 provides the reply creation unit 321 with the reply data. The reply timing adjustment unit 323 may include a plurality of buffers that are capable of storing a plurality of pieces of reply data and provide the reply creation unit 321 with reply data in, for example, a FIFO (First In First Out) manner.

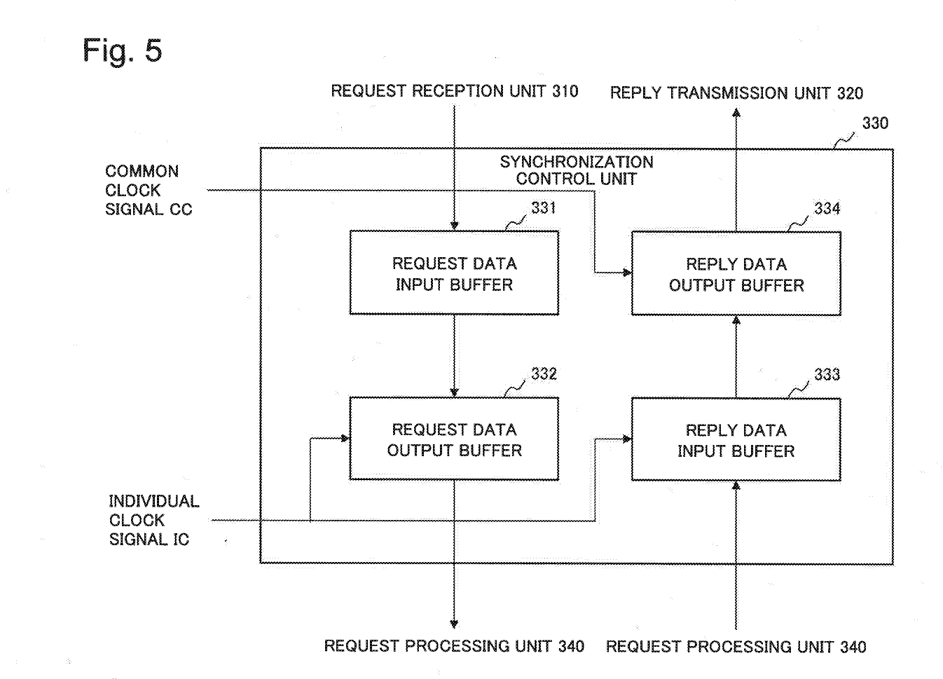

FIG. 5 is a block diagram conceptually illustrating a configuration of the synchronization control unit 330 according to the present example embodiment. The synchronization control unit 330 includes a request data input buffer 331, a request data output buffer 332, a reply data input buffer 333, and a reply data output buffer 334. To the request data input buffer 331 and the reply data output buffer 334, the common clock signal CC is input, and the buffers operate in synchronization with the common clock signal CC. To the request data output buffer 332 and the reply data input buffer 333, the individual clock signal IC is input, and the buffers operate in synchronization with the individual clock signal IC.

The request data input buffer 331 temporarily stores request data input from the request reception unit 310 and subsequently provide the request data output buffer 332 with the request data. The request data output buffer 332 temporarily stores the request data provided from the request data input buffer 331 and subsequently provides the request processing unit 340 with the request data at a timing synchronized with the individual clock signal IC.

The reply data input buffer 333 temporarily stores reply data input from the request processing unit 340 and subsequently provides the reply data output buffer 334 with the reply data. The reply data output buffer 334 temporarily stores the reply data provided from the reply data input buffer 333 and subsequently provides the reply transmission unit 320 with the reply data at a timing synchronized with the common clock signal CC.

The request processing unit 340 performs processing that is instructed by request data provided from the synchronization control unit 330. To the request processing unit 340, the individual clock signal IC is provided, and the request processing unit 340 operates in synchronization with the individual clock signal IC.

In the case in which the command type 102 illustrated in FIG. 3 indicates a write command, the request processing unit 340 writes data indicated by the write data 105 to an address indicated by the access destination address 104. In the case in which the command type 102 illustrated in FIG. 3 indicates a read command, the request processing unit 340 reads data from an address indicated by the access destination address 104 and subsequently creates a reply data based on the read data.

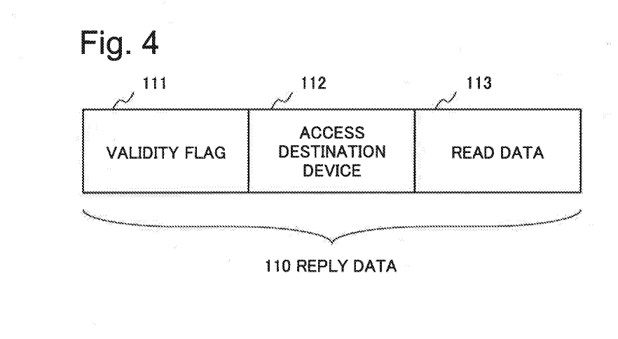

A configuration example of reply data that the request processing unit 340 creates is illustrated in FIG. 4. As illustrated in FIG. 4, reply data 110 includes a validity flag 111, an access destination device 112, and read data 113. The validity flag 111 is information indicating whether or not the reply data 110 are valid and contains “1” if valid or “0” if invalid. The request processing unit 340 sets the validity flag 111 at “1” in creating the reply data 110. The access destination device 112 is an identifier that makes it possible to identify a slave device that has issued the reply data 110. The request processing unit 340 sets, to the access destination device 112, an identifier that makes it possible to identify the slave device 30. The read data 113 are data that have been read by the request processing unit 340. The request processing unit 340 provides the synchronization control unit 330 with the created reply data.

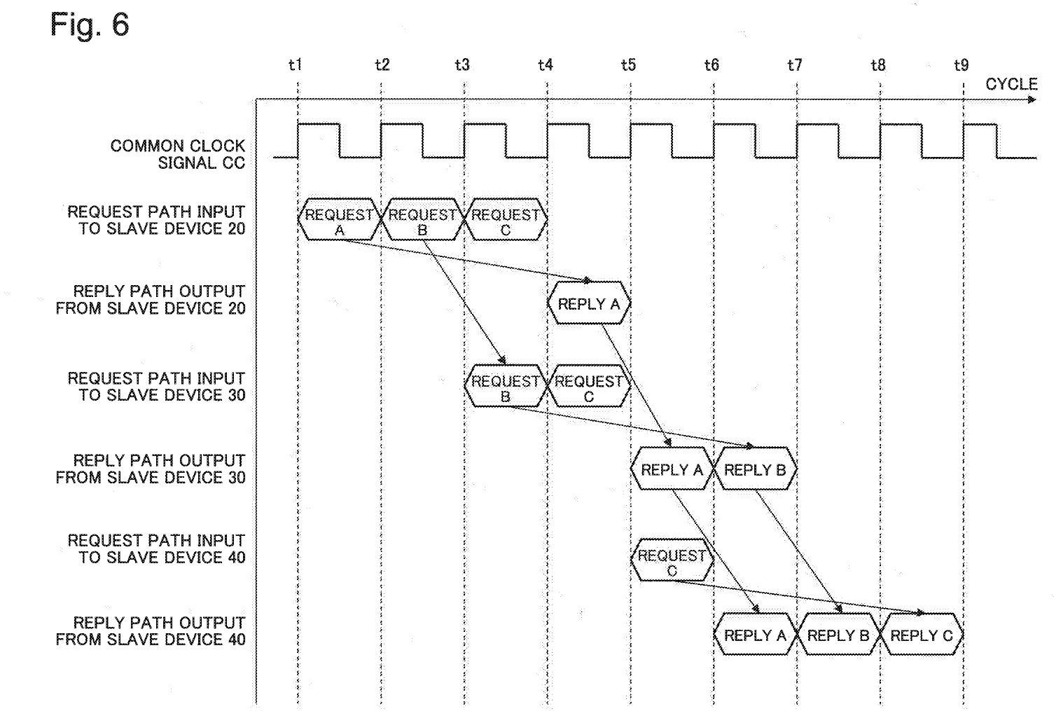

In FIG. 6, an example of a timing diagram relating to data that flow through a request path and a reply path according to the present example embodiment. In the case of the example illustrated in FIG. 6, each of the slave devices 20 to 40 is set to transfer, based on cycles regarding the common clock signal CC, after three cycles from receiving of the request data addressed to the slave device, created reply data to a slave device located at the succeeding stage or the master device 10.

In FIG. 6, requests A, B, and C are read requests that have been issued by the master device 10 addressed to the slave devices 20, 30, and 40, respectively. Replies A, B, and C are replies that the slave devices 20, 30, and 40 have created in response to the requests A, B, and C, respectively.

As illustrated in FIG. 6, the master device 10 outputs the requests A, B, and C to a request path input to the slave device 20 in cycles t1, t2, and t3, based on the common clock signal CC, respectively.

The slave device 20 processes the request A, which is a request addressed to the slave device, and subsequently outputs the reply A to a reply path output from the slave device 20 in cycle t4 after three cycles from t1. The slave device 20 outputs the requests B and C, which are requests addressed to other slave devices, to a request path input to the slave device 30 in cycles t3 and t4, respectively.

The slave device 30 processes the request B, which is a request addressed to the slave device, and subsequently outputs the reply B to a reply path output from the slave device 30 in cycle t6 after three cycles from t3. The slave device 30 outputs the request C, which is a request addressed to another slave device, to a request path input to the slave device 40 in cycle t5. The slave device 30 outputs the reply A, which has been created by another slave device, to a reply path output from the slave device 30 in cycle t5.

The slave device 40 processes the request C, which is a request addressed to the slave device, and subsequently outputs the reply C to a reply path output from the slave device 40 in cycle t8 after three cycles from t5. The slave device 40 outputs the replies A and B, which have been created by other slave devices, to a reply path output from the slave device 40 in cycles t6 and t7.

As described above, the requests A to C, which have been output from the master device 10, are processed by the slave devices 20 to 40 in cycles t1 to t3, respectively, and the replies A to C are subsequently output from the slave device 40, which is located at the final stage, in cycles t6 to t8, respectively.

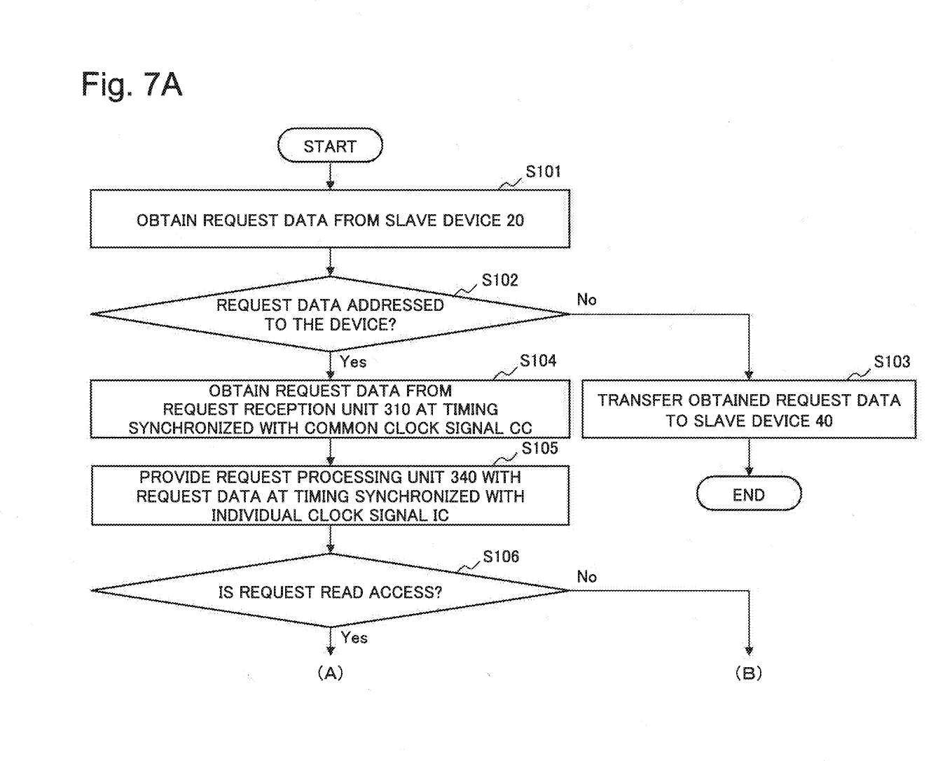

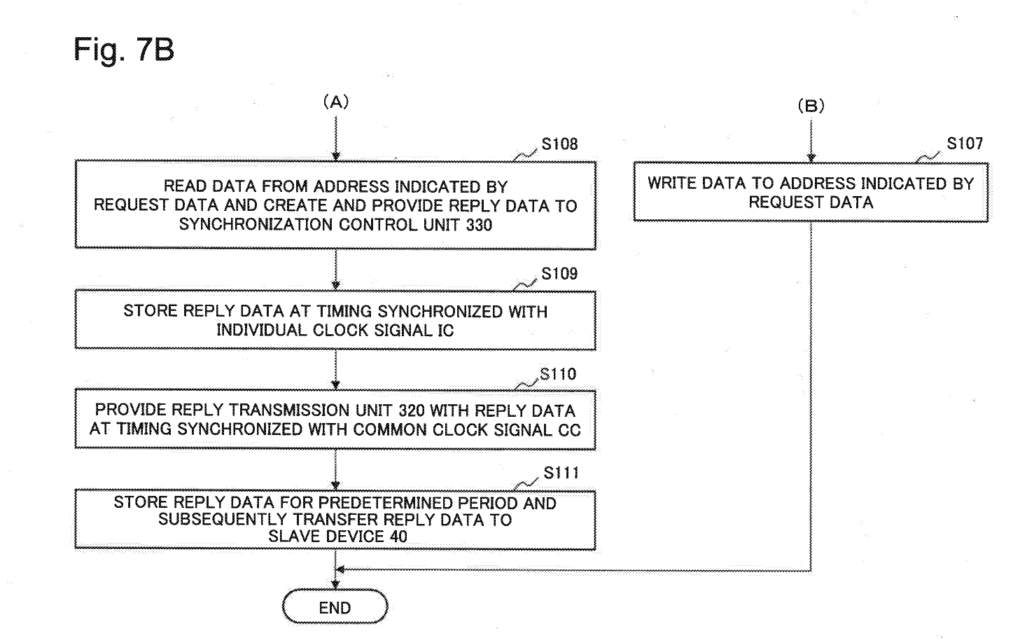

Next, with reference to flowcharts in FIGS. 7A and 7B, an operation (processing) of the data transfer control system 1 according to the present example embodiment will be described in detail using a case of the slave device 30 as an example. Operations of the slave devices 20 and 40 are the same as that of the slave device 30.

The request reception unit 310 obtains request data from the slave device 20 (step S101). In the case in which the request data is not addressed to the slave device (that is, the slave device 30) (No in step S102), the request reception unit 310 transfers the obtained request data to the slave device 40 (step S103). The whole processing is then finished.

In the case in which the request data is addressed to the slave device (Yes in step S102), the synchronization control unit 330 obtains the request data from the request reception unit 310 at a timing synchronized with the common clock signal CC (step S104). The synchronization control unit 330 provides the request processing unit 340 with the request data at a timing synchronized with the individual clock signal IC (step S105).

In the case in which the request is not a read access (that is, a write access) (No in step S106), the request processing unit 340 writes data to an address that the request data indicate (step S107). The whole processing is then finished.

In the case in which the request is a read access (Yes in step S106), the request processing unit 340 reads data from an address that the request data indicate, creates reply data, and provides the synchronization control unit 330 with the reply data (step S108).

The synchronization control unit 330 stores the reply data at a timing synchronized with the individual clock signal IC (step S109). The synchronization control unit 330 provides the reply transmission unit 320 with the reply data at a timing synchronized with the common clock signal CC (step S110). The reply transmission unit 320 stores the reply data for a predetermined period of time and subsequently transfers the reply data to the slave device 40 (step S111). The whole processing is then finished.

The data transfer control system 1 according to the present example embodiment may improve data transfer performance between information processing devices in a system as described below. That is, such a system is a system in which a plurality of information processing devices, each of which accesses data stored in the information processing device using an individual clock signal IC, are connected, and data relating to an access from another information processing device flow through a communication path that is relayed by the plurality of information processing devices. The reason for the improvement is as follows. That is, in each of the information processing devices (slave devices), the synchronization control unit, in synchronization with the common clock signal CC, provides the reply transmission unit with reply data that the information processing device has created in response to an access request. The reply transmission unit stores the reply data for a predetermined period of time and subsequently transfers the reply data to the information processing device located at the succeeding stage in synchronization with the common clock signal CC.

In a system in which a plurality of slave devices, such as peripheral devices, that are accessed by a master device are connected to the master device, each of such slave devices, in general, operates in synchronization with an individual clock signal IC that the slave device itself generates. In the case in which such slave devices are, for example, daisy-chained to one another, data relating to a request and a reply thereto flow through a shared communication path, which is relayed by the slave devices, to reach a destination device.

In this case, the respective slave devices output reply data to a reply path at timings that are not synchronized with one another among the slave devices. In this situation, there is a problem in that competition occurring frequently among reply outputs output from the plurality of slave devices in a shared reply path causes data transfer performance between the master device and the slave devices to be reduced.

On the other hand, in the data transfer control system 1 according to the present example embodiment, the common clock signal distribution device 50 distributes the common clock signal CC to the slave devices 20 to 40. In the case of, for example, the slave device 30, the synchronization control unit 330, in synchronization with the common clock signal CC, provides the reply transmission unit 320 with reply data that the slave device has created in synchronization with the individual clock signal IC. The reply transmission unit 320 in the slave device 30 stores the reply data provided from the synchronization control unit 330 for a predetermined period of time and subsequently outputs the reply data to a shared reply path in synchronization with the common clock signal CC. That is, the slave devices 20 to 40 output reply data to the reply path at timings that are synchronized with one another among the slave devices by way of the common clock signal CC. By avoiding reply outputs output from a plurality of slave devices from competing with one another in a shared reply path with this configuration, the data transfer control system 1 according to the present example embodiment may improve data transfer performance among the master device 10 and the slave devices 20 to 40.

In addition, in the data transfer control system 1 according to the present example embodiment, the reply transmission unit in each of the slave devices 20 to 40, after the slave device has received request data addressed to the slave device, stores reply data thereto for a predetermined period of time. Specifically, the reply transmission unit stores reply data for a predetermined period of time so that the time that it takes to output reply data to a reply path after each slave device has received request data addressed to the slave device becomes constant among the slave devices 20 to 40. For example, in the example illustrated in FIG. 6, the reply transmission unit in each of the slave devices 20 to 40 stores reply data so that the time that it takes to output reply data to a reply path after having received request data becomes three cycles based on the common clock signal. With this configuration, the data transfer control system 1 according to the present example embodiment may use a request path and a reply path efficiently as illustrated in FIG. 6, which enables data transfer performance among the master device 10 and the slave devices 20 to 40 to be further improved.

Moreover, in the data transfer control system 1 according to the present example embodiment, the reply transmission unit in each of the slave devices 20 to 40 includes a plurality of buffers that are capable of storing reply data for a predetermined period of time and is capable of reading reply data in a FIFO manner. With this configuration, the data transfer control system 1 according to the present example embodiment may successively process a plurality of requests that the master device 10 has issued, which enables system performance to be improved.

The data transfer control system 1 according to the present example embodiment is not limited to a system in which a plurality of slave devices are daisy-chained to a master device. For example, the technical idea included in the present example embodiment is also applicable to a system in which a plurality of circuits operating in synchronization with clock signals different from one another are daisy-chained in a single device.

Furthermore, the data transfer control system 1 according to the present example embodiment does not limit the form of interconnection among a plurality of information processing devices to daisy-chain connection. For example, the technical idea included in the present example embodiment is also applicable to a system described below that is a multi-node system in which a plurality of information processing device are connected in a mutually communicable manner using a connection form other than daisy-chain connection. That is, the technical idea included in the present example embodiment is applicable to a system and the like that have an architecture in which request data and reply data, after having been relayed by a plurality of information processing device, reach a destination device.

### Second Example Embodiment

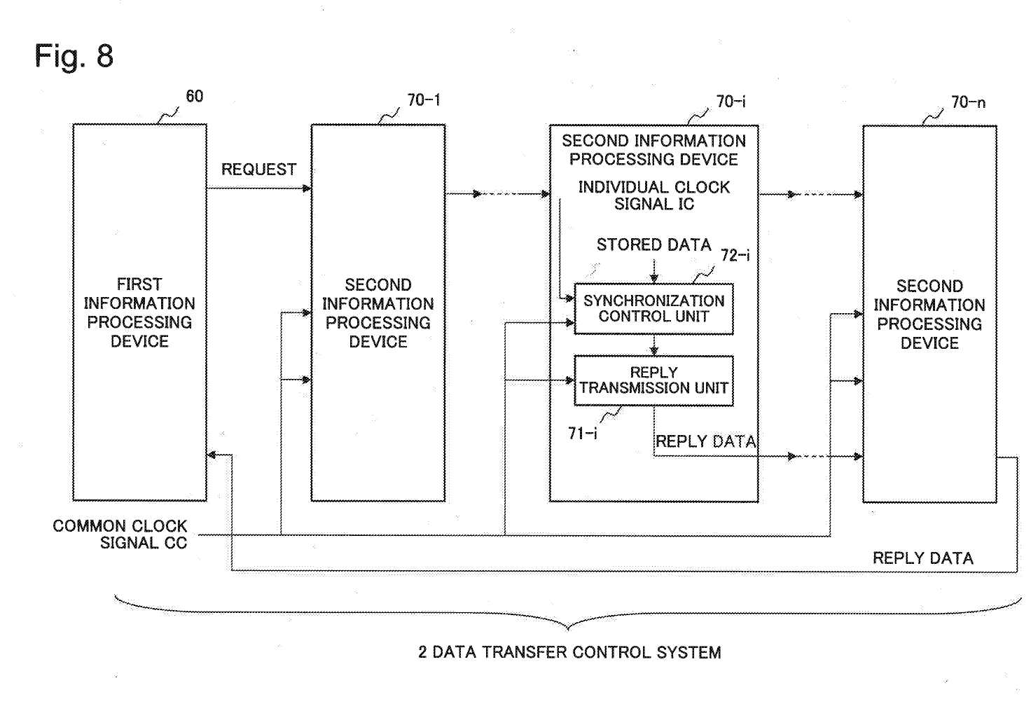

FIG. 8 is a block diagram conceptually illustrating a configuration of a data transfer control system 2 according to a second example embodiment.

The data transfer control system 2 according to the present example embodiment includes a first information processing device 60 and n (n is an integer not less than 2) second information processing devices 70-1 to 70-n. Each of the second information processing devices 70-1 to 70-n accesses stored data stored in the second information processing device in synchronization with an individual clock signal IC unique to the second information processing device. The first information processing device 60 accesses stored data stored in a specific second information processing device 70-i (i is any integer of 1 to n) among the second information processing devices 70-1 to 70-n. At this time, the first information processing device 60 obtains reply data that have been issued by the second information processing device 70-i and indicate a result of the access to the stored data using a communication path that are relayed in order by at least any of the second information processing devices except the second information processing device 70-i. In the case of the example illustrated in FIG. 8, reply data created by the second information processing device 70-i are relayed in order by the second information processing devices 70-(i+1) to 70-n and subsequently provided to the first information processing device 60.

The second information processing device 70-i includes a reply transmission unit 71-i and a synchronization control unit 72-i.

The synchronization control unit 72-i outputs reply data that the second information processing device 70-i creates in synchronization with the individual clock signal IC in synchronization with a common clock signal CC, which has been distributed to the second information processing devices 70-1 to 70-n in common.

The reply transmission unit 71-i operates in synchronization with the common clock signal CC. The reply transmission unit 71-i stores reply data that the synchronization control unit 72-i has output for a predetermined period of time and subsequently transmits the reply data to the second information processing device 70-(i+1), which is located at the succeeding stage, (in the case in which i=n does not hold) or to the first information processing device 60 (in the case in which i=n holds).

The data transfer control system 2 according to the present example embodiment achieves an advantageous effect in that it is possible to improve data transfer performance among information processing devices. Specifically, the data transfer control system 2 achieves the above-described advantageous effect in a system in which a plurality of information processing devices each of which accesses data stored in the information processing device using an individual clock signal IC are interconnected and data relating to an access from another information processing device flow through a communication path relayed by the plurality of information processing devices. The reason for the advantageous effect is a configuration described below. That is, in each of the second information processing devices, the synchronization control unit, in synchronization with the common clock signal CC, provides the reply transmission unit with reply data that the second information processing device has created in response to an access request. The reply transmission unit stores the reply data for a predetermined period of time and subsequently transfers the reply data to an information processing device located at the succeeding stage in synchronization with the common clock signal CC.

### Hardware Configuration Example

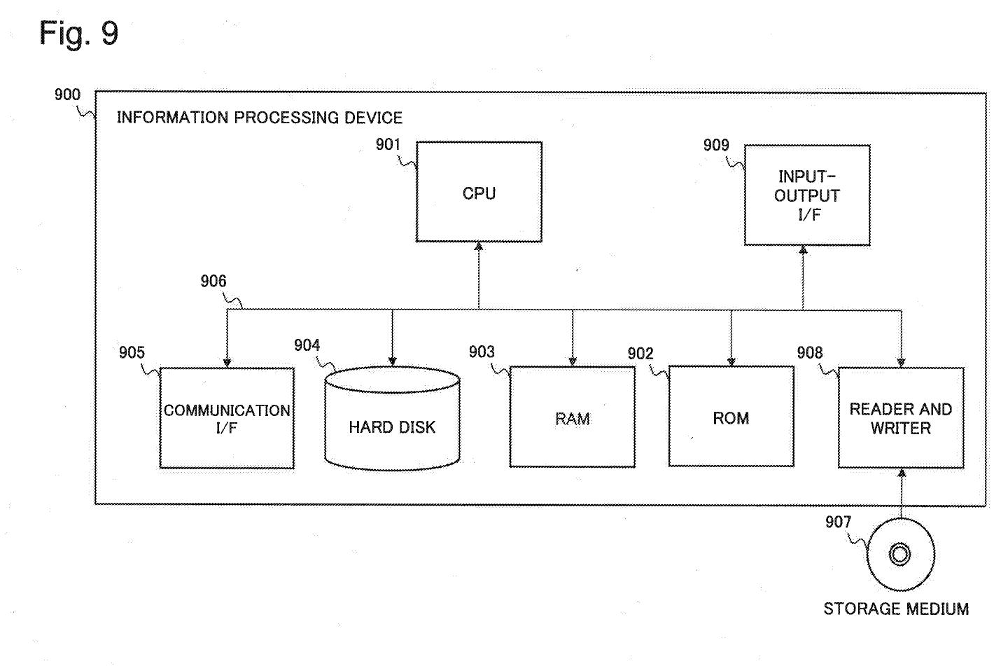

The respective components illustrated in FIGS. 2 and 8 in the respective above-described example embodiments may be achieved by dedicated HW (HardWare) (electronic circuits). In addition, at least the reply transmission units 320 and 71-i and the synchronization control units 330 and 72-i may be viewed as functional (processing) units (software modules) of a software program. However, division of the respective components illustrated in the drawings is a configuration for the purpose of description, and, in actual implementation, various configurations may be conceived. An example of a hardware environment in such a case will be described with reference to FIG. 9.

FIG. 9 is a diagram describing, in an exemplifying manner, a configuration of an information processing device 900 (computer) that is capable of executing a slave device or a second information processing device according to a typical example embodiment of the present invention. That is, FIG. 9 illustrates a hardware environment that is a configuration of a computer (information processing device) capable of achieving a slave device and a second information processing device illustrated in FIGS. 2 and 8, respectively, and is capable of achieving the respective functions in the above-described example embodiments.

The information processing device 900 illustrated in FIG. 9 includes the following components as composing elements:
a CPU (Central Processing Unit) 901;
a ROM (Read Only Memory) 902;
a RAM (Random_Access_Memory) 903;
a hard disk 904 (storage device);
a communication interface 905 (hereinafter, the “interface” will be referred to as “I/F”) with an external device;
a reader and writer 908 that is capable of reading and writing data stored in a storage medium 907, such as a CD-ROM (Compact_Disc_Read_Only_Memory); and
an input-output interface 909.
   The information processing device 900 is a general computer in which the components as described above are interconnected by way of a bus 906 (communication line).

The present invention that was described using the above-described example embodiments as examples provides the information processing device 900 illustrated in FIG. 9 with a computer program that is capable of achieving the following functions. The functions are functions of the reply transmission units 320 and 71-i and the synchronization control units 330 and 72-i in block configuration diagrams (FIGS. 2 and 8), which were referenced in the descriptions of the example embodiments, or functions described in the flowcharts (FIGS. 7A and 7B). The present invention is achieved by reading the computer program into the CPU 901 in the hardware and interpreting and executing the computer program subsequently. The computer program provided to the inside of the device may be stored in a readable and writable volatile storage memory (the RAM 903) or a non-volatile storage device, such as the hard disk 904.

In the case described afore, as a provision method of the computer program into the hardware, a method that is commonly used currently may be employed. Such methods include, for example, a method of installing the computer program into the device by way of various storage media 907 such as a CD-ROM and a method of downloading the computer program from the outside by way of a communication line such as the Internet. It may be viewed that, in such a case, the present invention is configured with code composing such a computer program or the storage medium 907 in which the code is stored. A portion or all of the respective components illustrated in the block configuration diagrams may be achieved by general-purpose or dedicated circuits, a processor, or a combination thereof. Such components may be configured with a single chip or a plurality of chips interconnected by way of a bus.

The present invention was described above using the above-described example embodiments as typical examples. However, the present invention is not limited to the above-described example embodiments. That is, various modes that could be understood by a person skilled in the art may be applied within the scope of the present invention.

This application is based upon and claims the benefit of priority from Japanese Patent Application No. 2014-195182 filed on Sep. 25, 2014, the entire disclosure of which is incorporated herein.

### INDUSTRIAL APPLICABILITY

The present invention is applicable to a system in which, for example, a plurality of information processing devices are connected in a daisy-chain connection, in which a master device connects a plurality of slave devices in a row.

### REFERENCE SIGNS LIST

1 Data transfer control system

10 Master device

20 to 40 Slave device

200 to 400 Data processing control unit

50 Common clock signal distribution device

100 Request data

101 Validity flag

102 Command type

103 Access destination device

104 Access destination address

105 Write data

110 Reply data

111 Validity flag

112 Access destination device

113 Read data

310 Request reception unit

311 Request distinguishing unit

312 Reply necessity determination unit

320 Reply transmission unit

321 Reply creation unit

322 Reply timing creation unit

323 Reply timing adjustment unit

330 Synchronization control unit

331 Request data input buffer

332 Request data output buffer

333 Reply data input buffer

334 Reply data output buffer

340 Request processing unit

2 Data transfer control system

60 First information processing device

70-1 to 70-n Second information processing device

71-i Reply transmission unit

72-i Synchronization control unit

900 Information processing device

901 CPU

902 ROM

903 RAM

904 Hard disk

905 Communication interface

906 Bus

907 Storage medium

908 Reader and writer

909 Input-output interface

What is claimed is:

1. A data transfer control system
in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order, the data transfer control system comprising,
with respect to each of the second information processing devices:
a memory storing instructions; and
one or more processors configured to execute the instructions to:
output the reply data that the second information processing device creates in synchronization with the individual clock signal in synchronization with a common clock signal that is distributed to the plurality of second information processing devices in common; and
operate in synchronization with the common clock signal and store, for a predetermined period of time, the output reply data the reply data being made up of a plurality of bits and being transmitted in one cycle based on cycles related to the common clock signal, and subsequently transmits the reply data to the second information processing device located at a succeeding stage or the first information processing device.

2. The data transfer control system according to claim 1, wherein
the one or more processors are further configured to execute the instructions to:
store the reply data for a predetermined period of time so that time that each of the second information processing device takes, after receiving request data from the first information processing device for the stored data stored in the second information processing device, the request data being made up of a plurality of bits and being transmitted in one cycle based on cycles related to the common clock signal, to transmit the reply data created in response to the request data becomes constant with respect to the plurality of second information processing devices.

3. The data transfer control system according to claim 1, wherein,
the one or more processors are further configured to execute the instructions to:
with respect to each of the second information processing devices,
operate in synchronization with the common clock signal and, in the case in which obtained request data from the first information processing device is addressed to the second information processing device, and provide the process of outputting the reply data in synchronization with the common clock signal with the request data,
wherein the one or more processors are further configured to execute the instructions to, in synchronization with the individual clock signal, output the request data obtained in synchronization with the common clock signal.

4. The data transfer control system according to claim 3, wherein
the one or more processors are further configured to execute the instructions to;
control
a request data input buffer that, in synchronization with the common clock signal, stores the request data provided from the process of providing the request data;
a request data output buffer that, in synchronization with the individual clock signal, stores the request data output from the request data input buffer;
a reply data input buffer that, in synchronization with the individual clock signal, stores the reply data created by the second information processing device; and
a reply data output buffer that, in synchronization with the common clock signal, stores the reply data output from the reply data input buffer.

5. The data transfer control system according to claim 3, wherein,
the one or more processors are further configured to execute the instructions to;
in the case in which obtained request data from the first information processing device are addressed to another second information processing device, transmit the request data to the second information processing device located at a succeeding stage.

6. The data transfer control system according to claim 1, wherein
the one or more processors are further configured to execute the instructions to;
control
one or more buffers that are capable of storing the reply data for a predetermined period of time and
read the reply data in a first-in-first-out manner.

7. The data transfer control system according to claim 1, wherein
the one or more processors are further configured to execute the instructions to;
generate the common clock signal and distribute the generated common clock signal to the plurality of second information processing devices.

8. The data transfer control system according to claim 1, wherein
the plurality of second information processing devices connect to the first information processing device in a daisy-chain form.

9. A data transfer control method
in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order, the data transfer control system comprising,
by the plurality of the second information processing devices:
outputting the reply data that the second information processing device creates in synchronization with the individual clock signal in synchronization with a common clock signal that is distributed to the plurality of second information processing devices in common; and
storing, for a predetermined period of time, the output reply data, the reply data being made up of a plurality of bits and being transmitted in one cycle based on cycles related to the common clock signal, and subsequently transmitting the reply data to the second information processing device located at a succeeding stage or the first information processing device in synchronization with the common clock signal.

10. A program storage medium storing a data transfer control program that causes a plurality of second information processing devices to execute:
in which, in performing an access to stored data stored in a specific information processing device from a plurality of second information processing devices each of which accesses stored data stored in the second information processing device in synchronization with an individual clock signal that is unique to the second information processing device, a first information processing device obtains reply data indicating a result from the access to the stored data, the result being issued by the specific information processing device, using a communication path that at least any of the plurality of second information processing devices except the specific information processing device relays in order,
a synchronization control process that outputs the reply data that the second information processing device creates in synchronization with the individual clock signal in synchronization with a common clock signal that is distributed to the plurality of second information processing devices in common; and
a reply transmission process that stores, for a predetermined period of time, the reply data output by the synchronization control process, the reply data being made up of a plurality of bits and being transmitted in one cycle based on cycles related to the common clock signal, and subsequently transmitting the reply data to the second information processing device located at a succeeding stage or the first information processing device in synchronization with the common clock signal.

11. The data transfer control system according to claim 1, wherein,
the one or more processors are further configured to execute the instructions to:
with respect to each of the second information processing devices,
operate in synchronization with the common clock signal and, in the case in which obtained request data from the first information processing device is addressed to the second information processing device, and provide the process of outputting the reply data in synchronization with the common clock signal with the request data,
wherein the one or more processors are further configured to execute the instructions to, in synchronization with the individual clock signal, output the request data obtained in synchronization with the common clock signal.

12. The data transfer control system according to claim 4, wherein
the one or more processors are further configured to execute the instructions to;
in the case in which obtained request data from the first information processing device are addressed to another second information processing device, transmits the request data to the second information processing device located at a succeeding stage.

13. The data transfer control system according to claim 2, wherein
the one or more processors are further configured to execute the instructions to;
control
one or more buffers that are capable of storing the reply data for a predetermined period of time and
read the reply data in a first-in-first-out manner.

14. The data transfer control system according to claim 3, wherein
the one or more processors are further configured to execute the instructions to;
control
one or more buffers that are capable of storing the reply data for a predetermined period of time and
read the reply data in a first-in-first-out manner.

15. The data transfer control system according to claim 4, wherein
the one or more processors are further configured to execute the instructions to;
control
one or more buffers that are capable of storing the reply data for a predetermined period of time and
read the reply data in a first-in-first-out manner.

16. The data transfer control system according to claim 2 wherein
the one or more processors are further configured to execute the instructions to;
generate the common clock signal and distribute the generated common clock signal to the plurality of second information processing devices.

17. The data transfer control system according to claim 3 wherein
the one or more processors are further configured to execute the instructions to;
generate the common clock signal and distribute the generated common clock signal to the plurality of second information processing devices.

18. The data transfer control system according to claim 4 wherein
the one or more processors are further configured to execute the instructions to;
generate the common clock signal and distribute the generated common clock signal to the plurality of second information processing devices.

19. The data transfer control system according to claim 2, wherein
the plurality of second information processing devices connect to the first information processing device in a daisy-chain form.

20. The data transfer control system according to claim 3, wherein
the plurality of second information processing devices connect to the first information processing device in a daisy-chain form.
